(19) United States
(12) Patent Application Publication
(10) Pub. No.: US 2023/0309770 A1
(43) Pub. Date: Oct. 5, 2023

(54) SELF-PROPELLED CLEANING MACHINE

(71) Applicant: Hobot Technology Inc., Chupei City (TW)

(72) Inventors: CHI-MOU CHAO, Zhubei City (TW); WEI-BO DING, Zhubei City (TW); HSUAN-YI LU, Zhubei City (TW)

(21) Appl. No.: 17/863,158

(22) Filed: Jul. 12, 2022

(30) Foreign Application Priority Data
Apr. 1, 2022 (CN) 202210337836.5

(51) Int. Cl. A47L 9/10; A47L 9/00; A47L 9/14; A47L 9/28; A47L 9/20; A47L 9/04; A47L 9/12; B01D 46/12; B01D 46/62; B01D 46/10; B01D 46/681

(52) U.S. Cl. CPC A47L 9/108; A47L 9/009; A47L 9/1409; A47L 9/2852; A47L 9/2842; A47L 9/20; A47L 9/0477; A47L 9/2873; A47L 9/281; A47L 9/122; B01D 46/12; B01D 46/62; B01D 46/103; B01D 46/681; A47L 2201/022; A47L 2201/04; B01D 2279/55

(57) ABSTRACT

The present invention discloses a self-propelled cleaning machine of which a control module controls a driving device to prompt a dust compressing member mounted in a dust box to be at a compressing position or a non-compressing position. The dust compressing member of the self-propelled cleaning machine is capable of compressing trash in the dust box to keep the compressed trash within a specific space inside the dust box, thereby achieving an effect of reducing the number of times that a user has to clear the dust box.

### CROSS-REFERENCE TO RELATED APPLICATIONS

This application claims priority of No. 202210337836.5 filed in China on 2022/04/01 under 35 USC 119, the entire content of which is hereby incorporated by reference.

### BACKGROUND OF THE INVENTION

### Field of the Invention

The present invention relates to an indoor cleaning device, and more particularly, to a self-propelled cleaning machine.

### Description of the Prior Art

In the prior art, a robot vacuum cleaner often employs physical effects of a vacuum device and a roller brush during cleaning, so as to roll up trash and suck it into a dust box. When long and thin trash is sucked in, for example, body hair, pet hair and fine strings, such long and thin trash can easily occupy a large space in the dust box in a way that the air flow in the dust box may be hindered from flowing smoothly. At this point in time, an air extraction module needs to use a larger power and a higher frequency in order to remove the trash from the dust box. The issue above is an undesirable complication for users.

In order to avoid an operation of clearing the trash from the dust box or reducing the number of times of the operation, the U.S. Patent Publication No. 20050150519 A1 discloses a cleaning robot system, which comprises a cleaning robot installed with a dust box, and a suction station having a suction unit for sucking dust and trash pieces in the dust box of the cleaning robot. However, a suction station of the cleaning robot having a suction unit has higher manufacturing costs. Considering that a user is still required to clear trash in a trash collecting container in the suction station, such suction station with higher manufacturing costs is not an ideal option.

In view of the above, there is a need for a cleaning robot system capable of reducing the number of times of an operation of clearing a dust box.

### SUMMARY OF THE INVENTION

It is an object of the present invention to provide a self-propelled cleaning machine comprising a dust compressing member for compressing trash in a dust box.

The object of the present invention can be achieved by the technical solution below.

A self-propelled cleaning machine includes a base, a walking module, a cleaning device, an air extraction module, a dust box, a dust compressing member, a driving device and a control module. The walking module neighbors with the base, and is configured to contact a floor when the self-propelled cleaning machine moves on the floor. The cleaning device is provided at the base and is for cleaning the floor. The air extraction module is arranged at the base, and is for generating an air flow between the cleaning device and the air extraction module. The dust box is arranged at the base, and is in communication with the cleaning device and the air extraction module. The dust compressing member is mounted in the dust box, and is selectively movable between a non-compressing position and a compressing position. The driving device is connected to the dust compressing member. The control module is electrically connected to the walking module, the air extraction module and the driving device. The control module is configured to control the driving device to move the dust compressing member to the non-compressing position or the compressing position.

The self-propelled cleaning machine above further includes: a filter module, disposed at the dust box, and located in a path of the air flow.

In the self-propelled cleaning machine above, the dust compressing member is configured such that the dust compressing member cleans a surface of the filter module when the dust compressing member switches from the non-compressing position to the compressing position.

In the self-propelled cleaning machine above, the dust compressing member includes a plate, the plate includes a connecting portion and a cleaning portion, the connecting portion of the dust compressing member is connected to the driving device, and the cleaning portion and the surface of the filter module are spaced by a gap when the dust compressing member cleans the surfaces of the filter module.

In the self-propelled cleaning machine above, the driving device is configured such that the dust compressing member rotates about the connecting portion as an axis, the cleaning portion of the dust compressing member is located at a free end of the dust compressing member, a position of the free end is opposite to a position of the cleaning portion, and the cleaning portion is configured such that the cleaning portion is spaced by a gap from the surface of the filter module during the rotating of the dust compressing member.

In the self-propelled cleaning machine above, the filter module includes: a filter; and a filter net, an inner surface of the filter net serving as the surface of the filter module and facing an inside of the dust box, the air flow first passing through the filter net and then passing through the filter, wherein the inner surface of the filter net includes an arc surface, and a shape of the arc surface matches a path of the rotating of the cleaning portion.

In the self-propelled cleaning machine above, the plate is a flat board, and the driving device is configured such that the dust compressing member moves from an upper side of the dust box to a lower side of the dust box.

In the self-propelled cleaning machine above, a guide groove is formed on an inner surface of the dust box, the guide groove extends from the upper side of the dust box to the lower side of the dust box, the driving device comprises a link rod, a gear set and a motor, the link rod has a track groove formed thereon, one pivotal end of the link rod is connected to the gear set, the motor is configured via the gear set such that the link rod rotates or sways about the pivotal end as an axis, the connecting portion of the plate is located in the guide groove and the track groove and is movable in the guide groove and the track groove, such that the dust compressing member moves from the upper side of the dust box to the lower side of the dust box, and an extension direction of the track groove is not parallel to an extension direction of the guide groove.

In the self-propelled cleaning machine above, the connecting portion further includes a connecting shaft and a limiting portion connected to the connecting shaft, the connecting shaft is located in the track groove, the limiting portion is in a long strip shape and is limited in the guide groove, and a shape of the limiting portion matches a shape of the guide groove such that the dust compressing member does not rotate around the connecting shaft.

In the self-propelled cleaning machine above, the filter module includes: a filter; and a filter net, an inner surface of the filter net serving as the surface of the filter module and facing an inside of the dust box, the air flow first passing through the filter net and then passing through the filter.

In the self-propelled cleaning machine above, the cleaning device includes a suction port.

In the self-propelled cleaning machine above, the cleaning device includes: a suction port; and a roller brush device, provided in the suction port.

In the self-propelled cleaning machine above, the control module is configured to control the driving device at a predetermined time interval such that the dust compressing member switches from the non-compressing position to the compressing position; alternatively, the control module is configured such that, when the self-propelled cleaning machine is being charged at a charging station, departs from the charging station, or has departed from the charging station for a predetermined period of time, the control module controls the driving device such that the dust compressing member switches from the non-compressing position to the compressing position; alternatively, a sensing module is disposed which includes a dust amount sensing module for sensing an amount of dust, and the control module is configured such that the dust compressing member switches from the non-compressing position to the compressing position when it is determined that the amount of dust has reached a predetermined value.

The self-propelled cleaning machine above further includes: a sensing module, capable of sensing information of the self-propelled cleaning machine walking on the floor; wherein the control module includes: a processor; and a memory, coupled to the processor, the memory including a non-transitory computer-readable storage medium having a computer-readable program code stored therein, the computer-readable program code executable by the processor so as to perform a cleaning operation, wherein the cleaning operation includes obtaining map information by the sensing module, receiving a cleaning command from a remote device, and prompting the self-propelled cleaning machine to perform cleaning according to the map information in response to the cleaning command.

The features and advantages of the present invention are as follows.

The present invention is provided with a dust compressing member. When needed, the dust compressing member can switch from a non-compressing position to a compressing position so as to compress trash in the dust box and the compressed trash is kept within a predetermined space of the dust box. Thus, the effect of reducing the number of times that a user has to clear the dust box is achieved.

### BRIEF DESCRIPTION OF THE DRAWINGS

FIG. 1 is a three-dimensional diagram of a self-propelled cleaning machine according to an embodiment of the present invention;

FIG. 2 is a three-dimensional bottom view of a self-propelled cleaning machine according to an embodiment of the present invention;

FIG. 3 is an exploded view of a self-propelled cleaning machine according to an embodiment of the present invention;

FIG. 4 is a three-dimensional exploded view and a diagram of assembly of a base, an air intake pipe and a dust box of a self-propelled cleaning machine according to an embodiment of the present invention;

FIG. 5A is a three-dimensional exploded view of a dust box without showing a dust compressing member according to an embodiment of the present invention;

FIG. 5B is a side view of a dust box according to an embodiment of the present invention;

FIG. 6A is a three-dimensional diagram of a dust box with a dust compressing member in a non-compressing state according to an embodiment of the present invention;

FIG. 6B is a three-dimensional diagram of a dust box with a dust compressing member in a compressing state according to an embodiment of the present invention;

FIG. 6C is a side view of a state of a dust box during a moving process of a dust compressing member according to an embodiment of the present invention;

FIG. 6D is a side view of another state of a dust box during a moving process of a dust compressing member according to an embodiment of the present invention;

FIG. 6E is a three-dimensional diagram of a dust box with a dust compressing member in a compressing state according to an embodiment of the present invention;

FIG. 6F is a three-dimensional diagram of a dust box with a dust compressing member in a non-compressing state according to an embodiment of the present invention;

FIG. 6G is a side view of a dust box with a dust compressing member respectively in a compressing state and in a non-compressing state according to an embodiment of the present invention;

FIG. 7A is a three-dimensional diagram of a state of a dust compressing member of a dust box according to an embodiment of the present invention;

FIG. 7B is a side view of a state of a dust compressing member of a dust box according to an embodiment of the present invention;

FIG. 7C is an exploded view of a dust box according to an embodiment of the present invention; and

FIG. 8 is a function block diagram of a self-propelled cleaning machine according to an embodiment of the present invention.

### DETAILED DESCRIPTION OF THE EMBODIMENTS

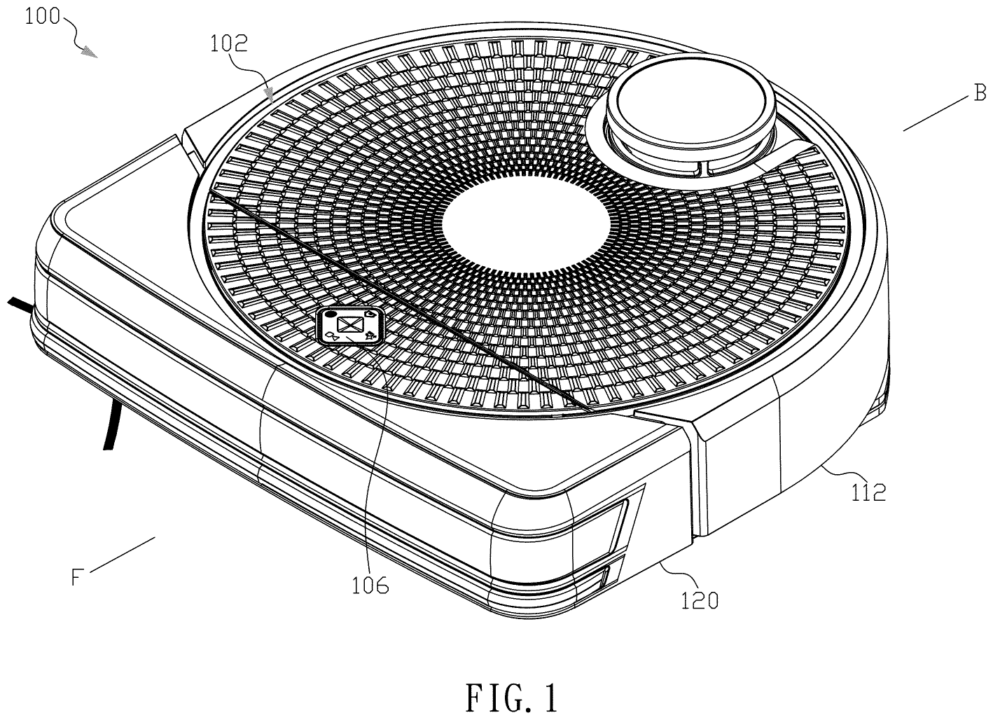

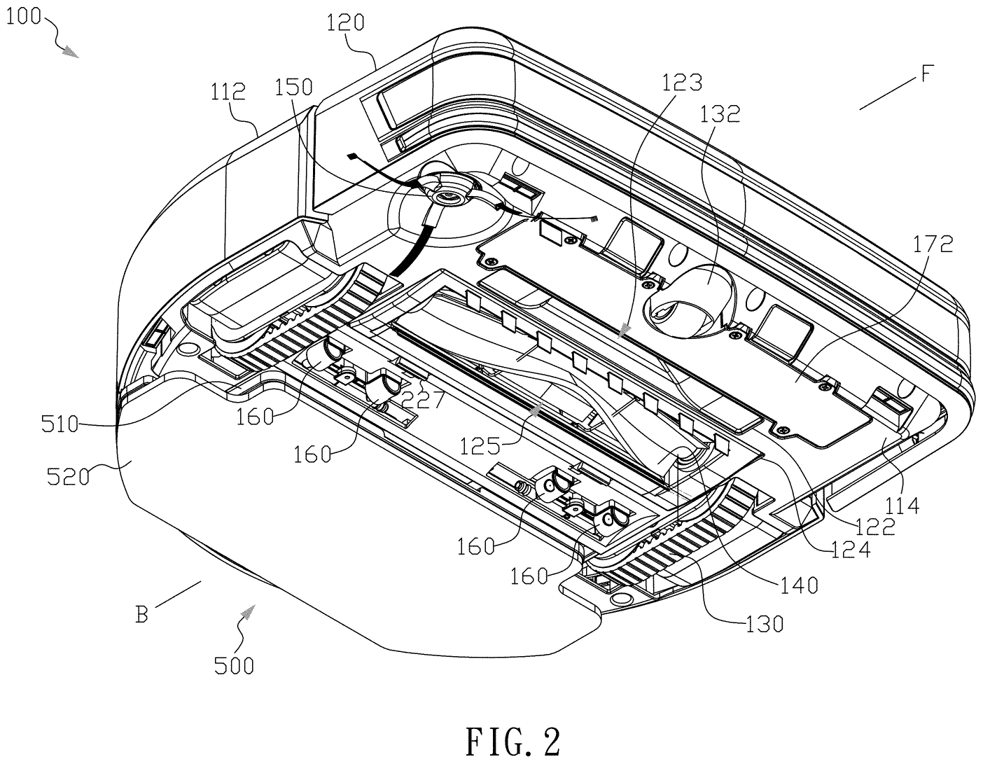

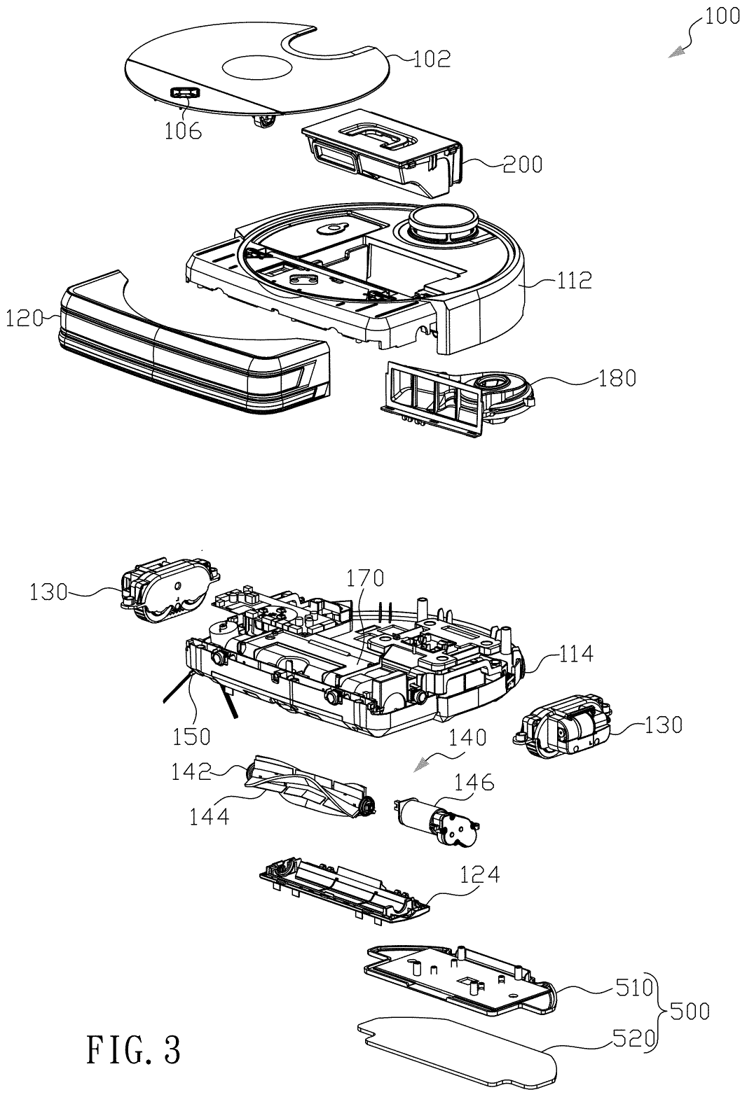

FIG. 1 shows a three-dimensional diagram of a self-propelled cleaning machine 100 according to an embodiment of the present invention. FIG. 2 shows a three-dimensional bottom view of the self-propelled cleaning machine 100 according to an embodiment of the present invention. FIG. 3 shows a three-dimensional exploded view of the self-propelled cleaning machine 100 according to an embodiment of the present invention. To better understand the operation principles of the self-propelled cleaning machine 100 disclosed by the present invention, detailed description is provided with the accompanying drawings below.

Referring to FIG. 1, the self-propelled cleaning machine 100 includes a bumper 120, a casing 112 and an upper cover 102. As shown in FIG. 1, in some embodiments, the self-propelled cleaning machine 100 further includes an operating panel 106 for a user to select an operating mode by means of touch control or pressing. The self-propelled cleaning machine 100 can freely move in different directions on a floor to be cleaned. For illustration purposes, in the present disclosure, the self-propelled cleaning machine 100 can move in a forward movement direction F and a backward movement direction B. The bumper 120 faces the forward movement direction F and serves as a front side of the self-propelled cleaning machine 100, and has a flat and straight appearance. A portion of the casing 112 faces the backward movement direction B and serves as a back side of the self-propelled cleaning machine 100, and has an arc appearance. However, the shapes of the bumper 120 and the casing 112 are not specifically defined in the present invention.

Referring to FIG. 2 and FIG. 3, the self-propelled cleaning machine 100 further includes various components, for example, a cleaning device 121, a walking module 130, a front wheel 132, a side brush device 150 and a water spray module 160. The cleaning device 121 is for cleaning the floor. The foregoing components are attached on the base 114, and extend outward or are exposed from a lower side of the base 114. In the present disclosure, for illustration purposes, the base 114 has an upper side and the lower side, which regard the orientation of the self-propelled cleaning machine 100 positioned to clean the floor as a reference point. The upper side refers to one side with its back facing the floor to be cleaned, and the lower side refers to one side facing the floor to be cleaned. In one embodiment, the self-propelled cleaning machine 100 further includes a battery module 170 attached on the base 114. In this embodiment, the cleaning device 121 can include, for example, a first suction portion 122, a second suction portion 124 and a roller brush device 140. However, the cleaning device 121 is not limited to the structure above, and can include only one suction portion 122, or can include only the second suction portion 124 and the roller brush device 140. In addition, the roller brush device 140 is located in a second suction port 125 of the second suction portion 124.

The walking module 130 neighbors with the base 114, located on two opposite sides of the base 114, exposed to the outside from the lower side of the base 114, and located in a center region of the base 114, and comes into contact with the floor to be cleaned when the self-propelled cleaning machine 100 moves on the floor. The walking module 130 can include a pair of walking components and a driving device. The walking components can be moving members such as pulleys and rollers. The driving device can be a combination of a motor, a gear and other transmission devices. The walking components are driven by the driving device, and then drive the self-propelled cleaning machine 100 to move forward, reverse or turn on the floor to be cleaned. In the embodiment shown, each walking component of the walking module is formed by a pulley, and includes a track wheel caterpillar track and two driving wheels that drive the caterpillar track.

The front wheel 132 is located in a front region of the self-propelled cleaning machine 100, and is closer to the front side of the self-propelled cleaning machine 100 than the walking module 130. In some embodiments, the front wheel 132 serves as an auxiliary wheel of the walking module 130, assists movement balance when the walking module 130 drives the self-propelled cleaning machine 100 to move, and thus may not be provided with an ability of driving the self-propelled cleaning machine 100.

Referring to FIG. 3, the self-propelled cleaning machine 100 further includes a dust box 200 and an air extraction module 180. The dust box 200 and the air extraction module 180 are located in the casing 112 above the base 114. The air extraction module 180 is in communication with the first suction portion 122 (not shown in FIG. 3) and the second suction portion 124 via the dust box 200. In one embodiment, the air extraction module 180 includes a pump. During an operation, air in the first suction portion 122 and the second suction portion 124 is extracted by the air extraction module 180, such that a negative pressure is formed inside the first suction portion 122 and the second suction portion 124 to thereby generate a suction force.

In one embodiment, the water spray module 160 is provided on the base 114 and can spray clear water or other cleaning liquids to wet the floor to be cleaned, so that dirt attached on the floor can be more easily removed to thereby enhance a cleaning effect of the self-propelled cleaning machine 100. In one embodiment, the self-propelled cleaning machine 100 includes a water supply module, which can be formed by a water tank, a pump and a water pipe. The water tank holds water or a cleaning liquid that is transported to the water spray module 160 via the water pipe. The pump applies a pressure on the clear water or cleaning liquid in the water pipe. In one embodiment, a nozzle of the water spray module extends from the lower side of the base 114 to the floor to be cleaned. In one embodiment, the water spray module 160 includes a water outlet, for example, a nozzle, and a water exit direction of the water spray module 160 can be controlled by adjusting a direction of the water outlet. Water or a cleaning liquid is sprayed from two sides of the base 114 toward the center region of the base, so that the clear water or cleaning liquid can be more effectively used by a cleaning cloth.

The base 114 is provided with the first suction portion 122. In one embodiment, the first suction portion 112 has a bezel formed by the base 114 and a first vacuum channel formed by a plurality of sidewalls. The first vacuum channel heads from the lower side of the base 114 to the upper side of the base 114. The first vacuum channel includes a first suction port 123 provided on the lower side of the base 114. The first suction portion 122 has the first suction port 123 on the lower side of the base 114. The first vacuum channel of the first suction portion 122 has a larger area on the lower side of the base 114, and has a tapered shape when further extended to the upper side of the base 114, thereby vacuum cleaning dust or trash of a greater range on the lower side.

In one embodiment, the first suction portion 122 sucks dust or dirt on the ground from the first suction port 123 into the dust box 200 by means of the negative pressure provided by the air extraction module 180. In one embodiment, the first suction portion 122 or the first suction port 123 is not provided with an assembly such as bristles or a brush for cleaning. Thus, when trash sucked in has a long and thin shape, for example, body hair, fine strings or pet hair, such type of trash does not get stuck in the first vacuum channel or the first suction port 123, and so the first suction portion 122 does not need to be cleaned on a regular basis and more maintenance time for the self-propelled cleaning machine 100 can be saved.

The base 114 is further provided with the second suction portion 124. In one embodiment, the second suction portion 124 has a bezel formed by the base 114 and a second vacuum channel formed by a plurality of sidewalls. The second vacuum channel includes a second suction port 125 provided on the lower side of the base 114, wherein the second suction port 125 neighbors with the first suction port 123. In one embodiment, the second suction port 125 and the first suction port 123 are spaced by a distance of less than 30 mm.

In one embodiment, the roller brush device 140 is provided on the base 114, and is surrounded by the second suction portion 124 and is exposed to the outside from the lower side. In one embodiment, the second suction portion 124 includes a roller brush lid 227 provided on the lower side of the base 114. The roller brush lid 227 may be annular and exposes the second suction port 125. The roller brush lid 227 may be an openable and closable design. When the roller brush lid 227 is opened, the roller brush device 140 can be taken out from the lower side of the base 114; when the roller brush lid 227 is closed, the roller brush device 140 is locked in the second suction port 125 on the base 114 by the roller brush lid 227, such that the roller brush device 140 can rotate steadily without swaying when a cleaning operation is performed.

As shown in FIG. 3, the roller brush device 140 includes a roller brush shaft 142 and a roller brush 144 provided on the roller brush shaft 142. In one embodiment, the roller brush shaft 142 is shaped as a rod, has two securing ends on two sides of the rod, and is detachably engaged on the base 114. The roller brush shaft 142 can be connected to the driving device 146, for example, a motor, via the securing ends, and rotates using power provided by the driving device 146. In one embodiment, the roller brush 144 is made of a flexible material, and has a shape of a brush or bristles. The roller brush 144 is attached to the roller brush shaft 142, and extends radially outward from the roller brush shaft 142 regarded as a center. During movement of the self-propelled cleaning machine 100, the roller brush 144 generates a torque by means of rotating the brush roller shaft 142 via the driving device 146, further driving the roller brush 144 to perform a circular motion with the roller brush shaft 142 as an axis. Accordingly, when the roller rush 144 rotates, dust or dirt is scraped off from the ground by a rotational force.

In one embodiment, the second suction portion 124 sucks dust or dirt on the ground from the second suction port 125 by means of the negative pressure provided by the air extraction module 180. In one embodiment, the second suction portion 124 is provided with the roller brush device 140 in the second suction port 125. Thus, when the floor to be cleaned contains dust adhered thereon or heavy trash, the adhered dust or the heavy trash can be removed by means of a vacuum suction force of the air extraction module 180 and a rotational torque of the roller brush device 140, thereby sucking in through the second suction portion 124 the trash that cannot be completely cleaned by the first suction portion 122, hence enhancing the cleaning effect of the self-propelled cleaning machine 100.

Referring to FIG. 3, the side brush device 150 is provided on the lower side of the base 114. The side brush device 150 can be provided near any corner of the self-propelled cleaning machine 100 close to the front side, for example, provided between the front side and the first suction portion 122 of the self-propelled cleaning machine 100 and close to a side of the self-propelled cleaning machine 100 or the base 114. With the coordination of the movement of the self-propelled cleaning machine 100 and the cleaning of the side brush device 150, dust or dirt on the ground can be pushed by the side brush device 150 further close to the position of the first suction port 123 or the second suction port 125, and can be more easily sucked into the first suction port 123 or the second suction port 125.

Referring to FIG. 1 to FIG. 3, in one embodiment, the self-propelled cleaning machine 100 includes a battery module 170, and the base 114 is further provided with a battery lid 172 located on the lower side of the base 114. The battery module 170 is mounted on the base 114, the battery lid 172 can secure the battery module 170 in the base 114, and the battery module 170 can be replaced by means of opening the battery lid 172.

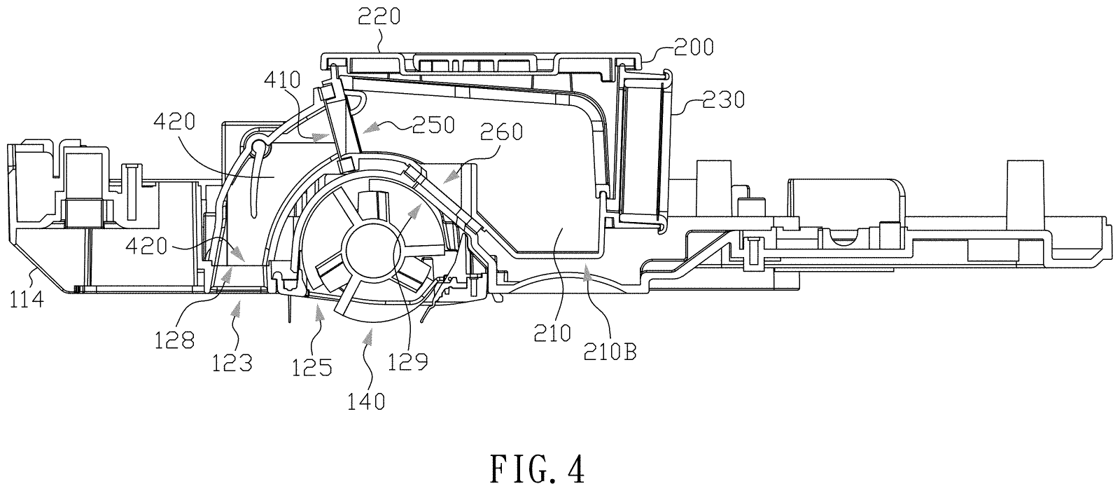

In one embodiment, a sidewall of the first suction portion 122 extends from the first suction port 123 toward the upper side of the base 114, and forms an opening 128 near the second suction portion 124 (as shown in FIG. 4). The opening 128 and the first suction port 123 are respectively located on the upper side and the lower side of the base 114, and serve as two openings of the first suction portion 122. In one embodiment, a sidewall of the second suction portion 124 forms, on the upper side of the base 114, an accommodating space for accommodating the roller brush device 140. In one embodiment, the accommodating space has a shape of a cylinder; however, the present invention does not define the shape of the accommodating space of the second suction portion 124, and other shapes are also encompassed within the scope of the embodiments of the present invention. The sidewall of the second suction portion 124 forms an opening 129 on an upper side of the accommodating space. As shown in FIG. 4, the opening 129 and the second suction port 125 are respectively located on the upper side and the lower side of the base 114, and serve as two openings of the second suction portion 124. The roller brush device 140 is provided in the second suction port 125 and is located between the second suction port 125 and the opening 129.

The dust box 200 is accommodated in an accommodating space provided in the casing 112. The self-propelled cleaning machine 100 further includes an air intake pipe 400 located between the casing 112 and the base 114. Referring to FIG. 4, the dust box 200, the air intake pipe 400 and the base 114 are sequentially connected after being assembled. The air intake pipe 400 has sidewalls so as to form an upper opening 410 and a lower opening 420. The lower opening 420 is connected to the opening 128 of the first suction portion 122, and the upper opening 410 is connected to the dust box 200. In one embodiment, a pipe wall of the air intake pipe 400 is curved, and extends along the shape (for example, a curved surface) of the sidewall of the second suction portion 124. Thus, internal utilization efficiency of the self-propelled cleaning machine 100 can be maximized, and the volume of the self-propelled cleaning machine 100 can then be reduced. In one embodiment, the air intake pipe 400 has a shape of gradually reducing from the lower opening 420 to the upper opening 410, such that an aperture of the first vacuum channel gradually increases from a first opening 250 of the dust box 200 to the first suction port 123. In this case, an area of the first suction port 123 is greater than areas of the opening 128 and the lower opening 420, and the area of the lower opening 420 is greater than an area of the upper opening 410, such that the first vacuum channel has a gradually tapered shape.

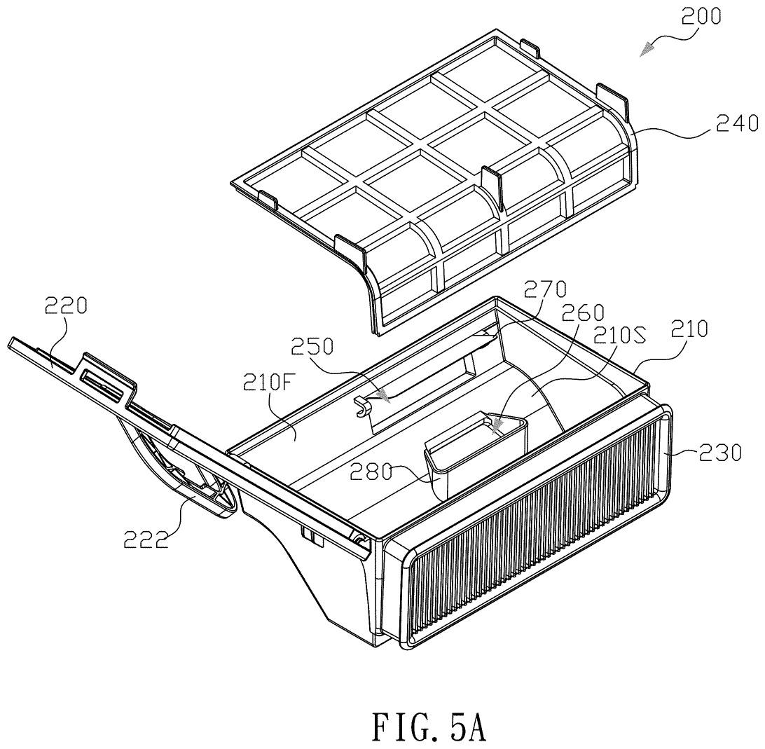

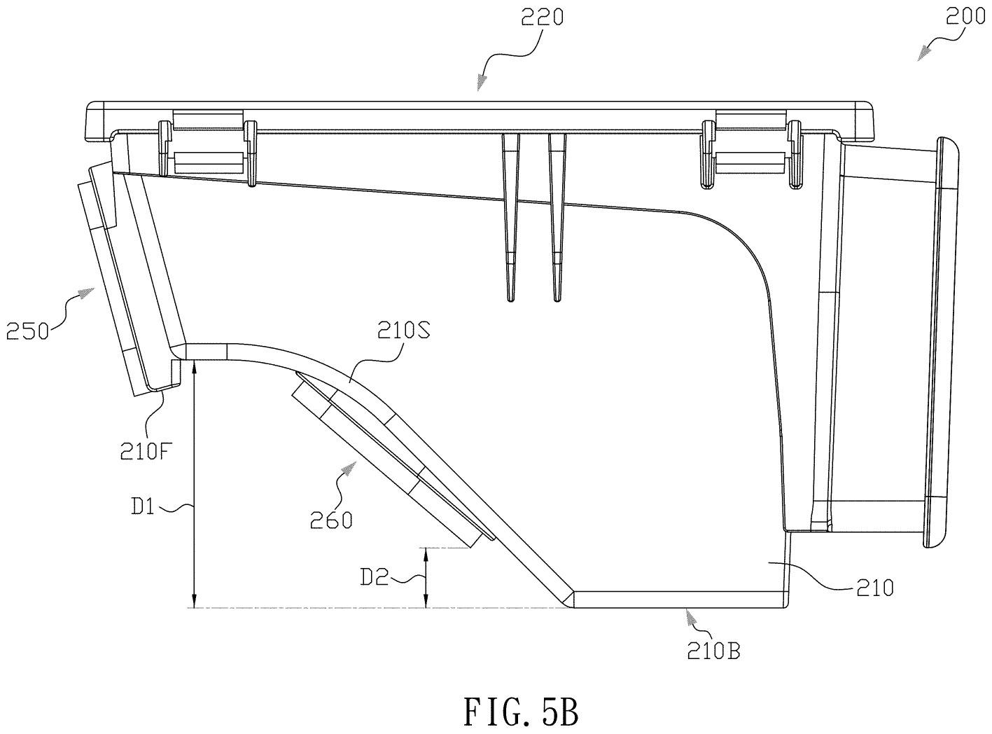

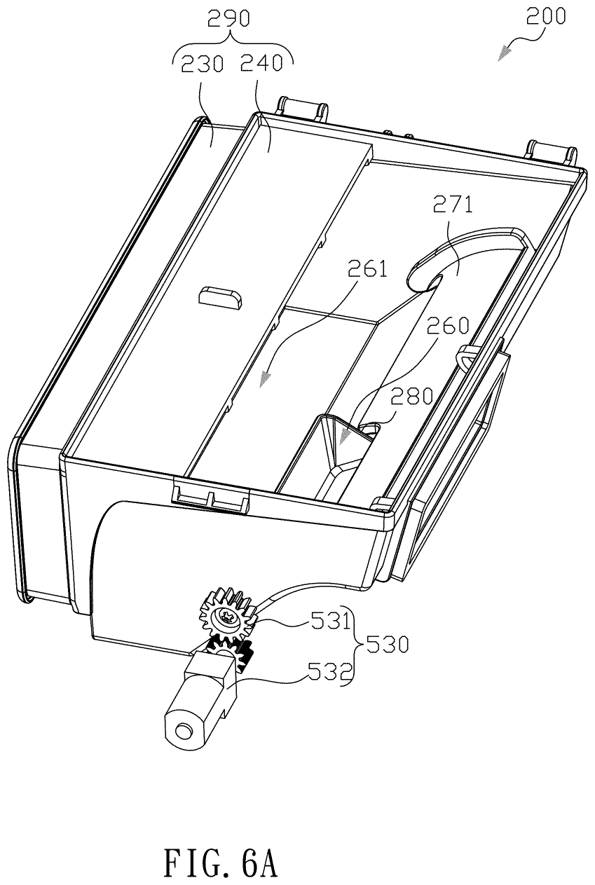

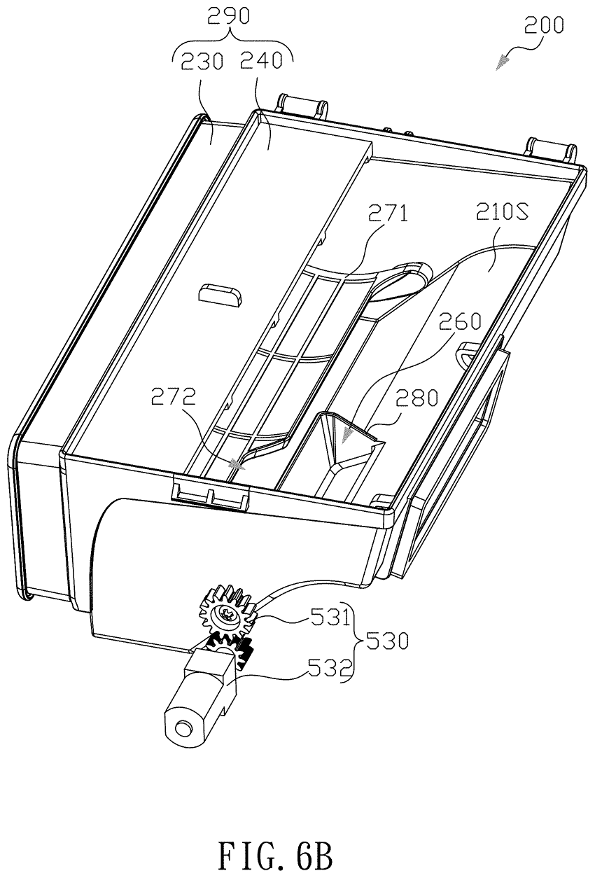

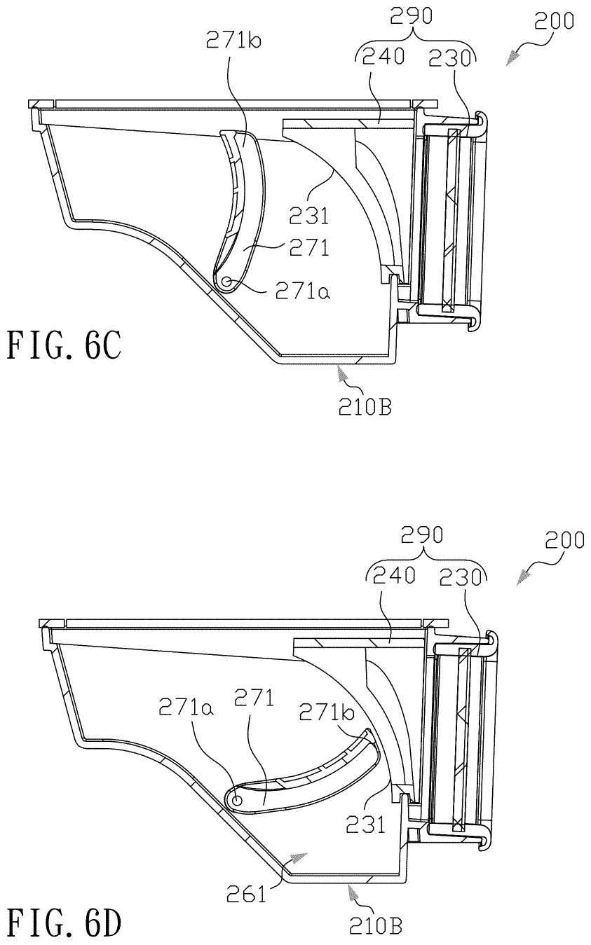

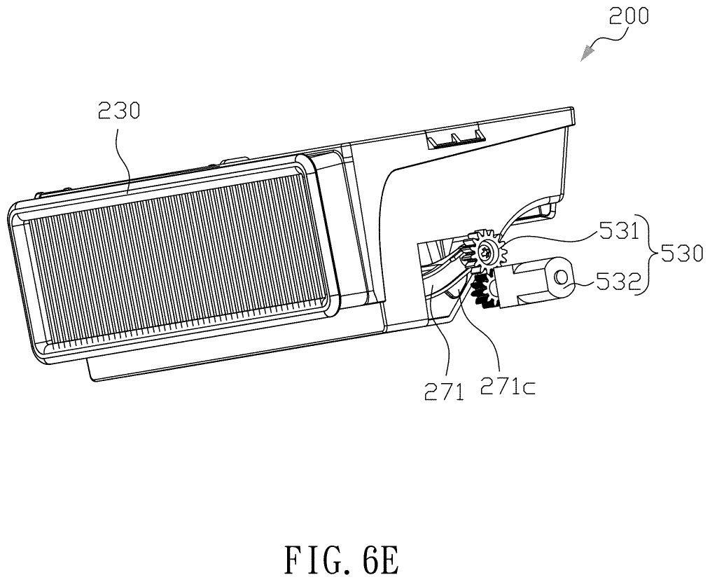

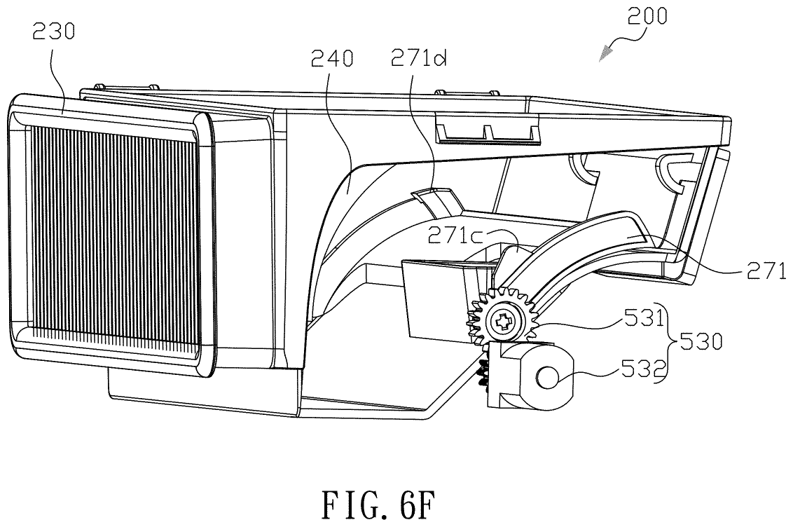

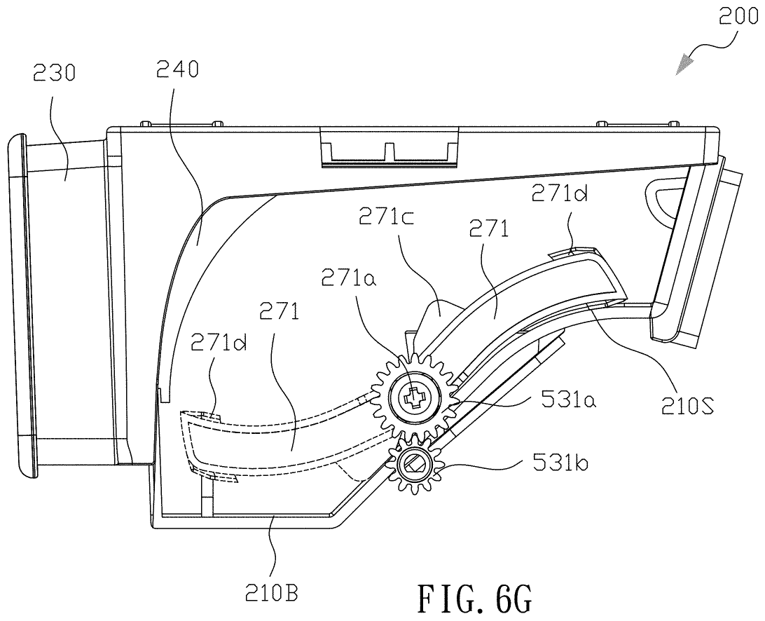

FIG. 5A shows a three-dimensional exploded view of a dust box according to an embodiment of the present invention. To more clearly show the structure of the dust box 200 outside the dust compressing member 271, the dust compressing member 271 is omitted from FIG. 5A. Referring to FIG. 5A, the dust box 200 includes a body 210, an upper lid 220, a handle 222 and a filter module 290. The filter module 290 (as shown in FIG. 6A) is located in a path of an air flow generated by the air extraction module 180, and includes a filter 230 and a filter net 240. The filter net 240 can be a net with a small mesh for filtering out large-sized trash, and the filter 230 can be a high-efficiency particulate air (HEPA) filter for filtering out small-sized dust. In one embodiment, the upper lid 220 may be a design that can be opened and closed. The body 210 is provided with a pivot at an upper edge on one side, such that the upper lid 220 is pivotally connected to the body 210 via the pivot. The upper lid 220 can be sealed with the body 210 when closed, preventing dust and trash having been sucked in from again leaking out of the dust box 200. When the upper lid 220 is opened, dust and trash collected in the dust box 200 can be removed. The handle 222 on the upper lid 220 facilitates a user to pull out the dust box 200 from the casing 112 and to further remove trash from the dust box 200.

In one embodiment, the body 210 of the dust box 200 is quadrilateral, and corresponds to the shape of the upper lid 220. However, in other embodiments, the body 210 of the dust box 200 may have other shapes. In one embodiment where the body 210 is quadrilateral, the body 210 at least has four surfaces, for example, a front side having a front sidewall 210F (for example, located on a front side of the body 210 facing the air intake pipe 400), a back side attached with the filter 230, and left and right sides respectively having a left sidewall and a right sidewall for connecting to the front sidewall 210F and the filter 230 on the back side. The body 210 is further provided, between the front sidewall 210F and a bottom surface 2106, with a fifth sidewall 210S that has an inclined surface such that an area of the front sidewall 210F is smaller than an area of the back side. In one embodiment, with the design of the inclined surface of the fifth sidewall 210S, the left sidewall and the right sidewall have a shape that is narrow on the front and wide on the back, and narrow on the bottom and wide on the top.

Referring to FIG. 5B, the body 210 is provided with the first opening 250 and a second opening 260. The first opening 250 is located on the front sidewall 210F, and the second opening 260 is located on the fifth sidewall 210S, such that the first opening 250 is above the second opening 260. The front sidewall 210F or the first opening 250 and the bottom surface 210B are spaced approximately by a distance D1, and the second opening 260 and the bottom surface 210B are spaced by a distance D2. Referring to FIG. 5A, the body 210 is provided with an opening lid 270 at the first opening 250, and the opening lid 270 exhibits a naturally closed state when no air flow passes through the first opening 250, so as to ensure that dust and trash in the dust box 200 do not leak out. Similarly, the body 210 is provided with a sidewall 280 near the second opening 260, and the sidewall 280 serves as a block wall that surrounds the second opening 260 from the inside. Further with the second opening 260 higher than the bottom surface 210B by a distance D2, the sidewall 280 and the bottom surface 210B form an accommodating space, hence increasing a space of the dust box 200 for accommodating trash.

FIG. 5B shows a side view of a dust box according to an embodiment of the present invention. Referring to FIG. 5B, when observed from a side surface of the dust box 200, since the left sidewall or the right sidewall of the body 210 has a shape that is wide on the top and narrow on the bottom, the first opening 250 projects more forward compared to the second opening 260. In one embodiment, when observed from the front, the first opening 250 and the second opening 260 overlap in the vertical direction; when observed from the side, the first opening 250 and the second opening 260 do not overlap in the vertical direction. In one embodiment, an included angle formed by the first opening 250 and the bottom surface 210B of the dust box 200 becomes a first acute angle, and an included angle formed by the second opening 260 and the bottom surface 210B of the dust box 200 becomes a second acute angle, wherein the first acute angle is greater than the second acute angle. In one embodiment, the first opening 250 and the second opening 260 are provided on opposite sides of the filter 230, the first opening 250 projects more forward than the second opening 260, the first opening 250 is closer to the top compared to the second opening 260, the second opening 260 is located on the fifth sidewall 210S that is an inclined surface, the fifth sidewall 210S has a shape that matches the pipe wall of the air intake pipe 400 and the two extend together along the shape of the sidewall of the second suction portion 124, so that the above components of the self-propelled cleaning machine 100 can be more tightly structured.

In one embodiment, referring to FIG. 2, the first suction portion 122, the second suction portion 124, the water spray module 160 and a wiping module 500 are sequentially arranged from front to back from the front side of the self-propelled cleaning machine 100. The first suction portion 122 and the second suction portion 124 are located on the front half of the base 114, and the water spray module 160 and the wiping module 500 are located on the back half of the base 114. In one embodiment, the wiping module 500 includes a cleaning cloth seat 510, which is arranged on the lower side of the base 114 and has a flat surface parallel to the floor to be cleaned. In one embodiment, one side of the cleaning cloth seat 510 that faces the floor to be cleaned is for attaching or adhering a cleaning cloth 520, so as to clean the floor along a movement direction F of the self-propelled cleaning machine 100. The cleaning cloth seat 510 may be provided with an attaching member, such as a hook and loop fastener, so as to detachably adhere the cleaning cloth 520 on the cleaning cloth seat 510.

Also referring to FIG. 6A and FIG. 6B, in one embodiment, the dust compressing member 271 is mounted in the dust box 200, and the dust compressing member 271 is movable between a non-compressing position and a compressing position. The dust compressing member 271 can compress trash in the dust box 200 when located at the compressing position, so that the dust box 200 can accommodate more trash, thus achieving the effect of reducing the number of times of clearing the dust box. More specific details are given in the description below.

In one embodiment, the dust box 200 is arranged at the base 114, and is in communication with the cleaning device 121 and the air extraction module 180. In one embodiment, the cleaning device 121 can include only the first suction portion 122. The first suction portion 122 is defined with the first suction port 123, the dust box 200 is in communication with the first suction port 123 and the air extraction module 180, and the air extraction module 180 generates an air flow between the first suction port 123 of the cleaning device 121 and the air extraction module 180, so as to suck trash into the dust box 200. In one embodiment, the cleaning device 121 can include the second suction portion 124 and the roller brush device 140, and the roller brush device 140 is provided in the second suction port 125 of the second suction portion 124. The air extraction module 180 generates an air flow between the second suction port 125 of the cleaning device 121 and the air extraction module 180, and dust or trash rolled up by the roller brush device 140 is then sucked into the dust box 200 by the airflow. In the embodiments shown in FIG. 2 and FIG. 3, the cleaning device 121 can simultaneously include the first suction portion 122, the second suction portion 124 and the roller brush device 140.

FIG. 6A shows a three-dimensional diagram of the dust box 200 with the dust compressing member 271 being in a non-compressing state according to an embodiment of the present invention. FIG. 6B shows a three-dimensional diagram of the dust box 200 with the dust compressing member 271 being in a compressing state according to an embodiment of the present invention. As shown in FIG. 6A and FIG. 6B, the self-propelled cleaning machine 100 further includes a dust compressing member 271 and a driving device 530. The dust compressing member 271 is mounted in the dust box 200 and is connected to the driving device 530. The driving device 530 includes a gear set 531 and a motor 532. The gear set 531 includes a plurality of gears, and one gear of the gear set 531 is located on an outer side of the sidewall of the dust box 200 and is connected to the dust compressing member 271. The motor 532 rotates the dust compressing member 271 via the gear set 531, such that the dust compressing member 271 is at a non-compressing position or a compressing position.

In one embodiment, in the state in FIG. 6A, a connecting end of the dust compressing member 271 is located closer to a lower side of the dust box 200, a free end of the dust compressing member 271 is located closer to an upper side of the dust box 200, and the dust compressing member 271 has a shape that matches the shape of the fifth sidewall 210S so as to be able to fit to or close to the fifth sidewall 210S. In one embodiment, the dust compressing member 271 is further defined with a notch 272 that is defined on one side of the dust compressing member 271 close to the gear set 531. The notch 272 has a shape that matches the shape and the volume of the sidewall 280, so that the dust compressing member 271 does not touch the sidewall 280 while it moves. In the state in FIG. 6B, the free end of the dust compressing member 271 faces a surface of the filter module 290, and compresses trash within a space 261 between a top surface of the sidewall 280 and the bottom surface 210B of the dust box 200.

FIG. 6C shows a side view of a state of a dust box during a moving process of a dust compressing member according to an embodiment of the present invention. FIG. 6D shows a side view of another state of a dust box during a moving process of a dust compressing member according to an embodiment of the present invention. As shown in FIG. 6C and FIG. 6D, in one embodiment, the dust pressing member 271 is a plate, and has a slightly curved shape so as to match the shape of the fifth sidewall 210S. The plate-shaped dust compressing member 271 includes a connecting portion 271a and a cleaning portion 271b located on two opposite sides. In one embodiment, the connecting portion 271a is at least one connecting shaft, and is preferably two connecting shafts respectively pivotally connected to two opposite sidewalls of the dust box 200. The connecting portion 271a (for example, one of its connecting shafts) of the dust compressing member 271 is connected to the driving device 530. Moreover, while the dust compressing member 271 cleans a surface 231 of the filter module 290, the cleaning portion 271b and the surface 231 of the filter module 290 are spaced by a gap. The benefit of being spaced by a gap is to prevent mutual interference between the dust compressing member 271 and the filter module 290. In one embodiment, the gap is between 0.1 mm and 2 mm, and is preferably between 0.2 mm and 2 mm, which is a range in which the cleaning portion 271b can clean cotton flocks attached on the surface 231 of the filter module 290. In one embodiment, the cleaning portion 271b and the surface 231 of the filter module 290 can also come into contact with each other. Preferably, soft bristles facing the surface 231 are formed on a top surface of the cleaning portion 271b. By contacting the bristles with the surface 231, the dust compressing member 271 and the filter module 290 can come into contact in a smoother manner, allowing the dust compressing member 271 to more easily brush over the surface 231.

As shown in FIG. 6C and FIG. 6D, in one embodiment, the driving device 530 is configured such that the dust compressing member 271 rotates about the connecting portion 271a as an axis, the cleaning portion 271b of the dust compressing member 271 is located at a free end of the dust compressing member 271, a position of the free end is opposite to a position of the connecting portion 271a, and the cleaning portion 271b is configured to be spaced by a gap from the surface 231 of the filter module 290 during the rotating of the dust compressing member 271. In one embodiment the filter module 290 includes the filter 230 and the filter net 240. The filter 230 is closer to an outer side of a sidewall of the dust box 200, and the filter net 240 is closer to an inner side of the sidewall of the dust box 200. An inner surface of the filter net 240 serves as the surface 231 of the filter module 290 and faces the inside of the dust box 200, so that an air flow for vacuuming passes through the filter net 240 and then passes through filter 230. In a preferred situation, the inner surface (the surface 231) of the filter net 240 appears as an arc surface, and a shape of the arc surface matches a path of the rotating of the cleaning portion 271b.

FIG. 6E shows a three-dimensional diagram of a dust box with a dust compressing member in a compressing state according to an embodiment of the present invention. FIG. 6F shows a three-dimensional diagram of a dust box with a dust compressing member in a non-compressing state according to an embodiment of the present invention. In FIG. 6E and FIG. 6F, the sidewall of the dust box 200 is partially hollowed to expose a part of the dust compressing member 271. As shown in FIG. 6E and FIG. 6F, the dust compressing member 271 further includes a limiting portion 271c. The limiting portion 271c protrudes from a side surface of the dust compressing member 271 used for compression, and the side surface used for compression faces an inclined surface between the fifth sidewall 210S and the bottom surface 210B of the dust box 200. When the dust compressing member 271 is at the compressing position, the limiting portion 271c presses against the inclined surface so as to limit a maximum rotation angle of the dust compressing member 271.

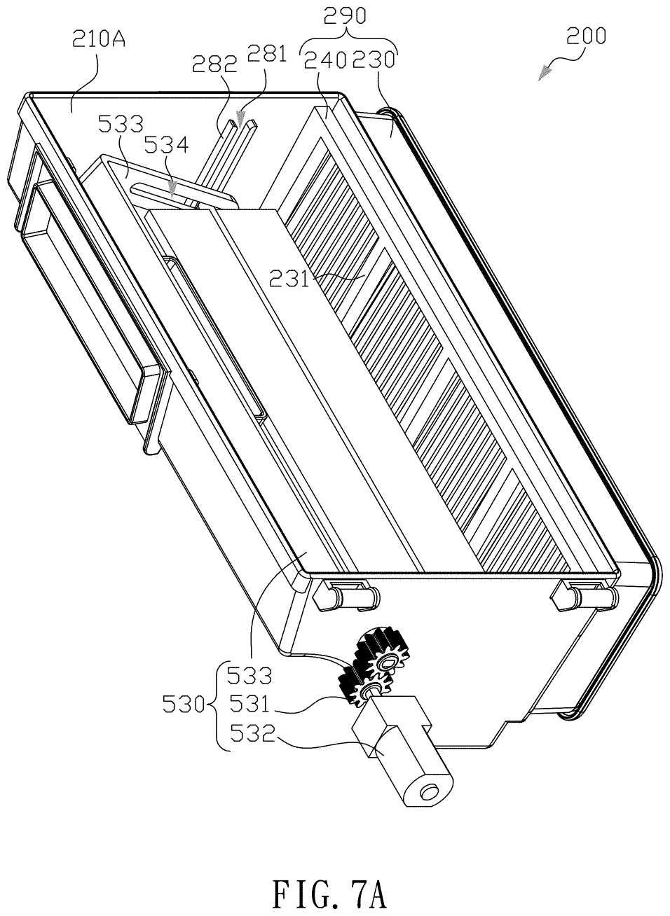

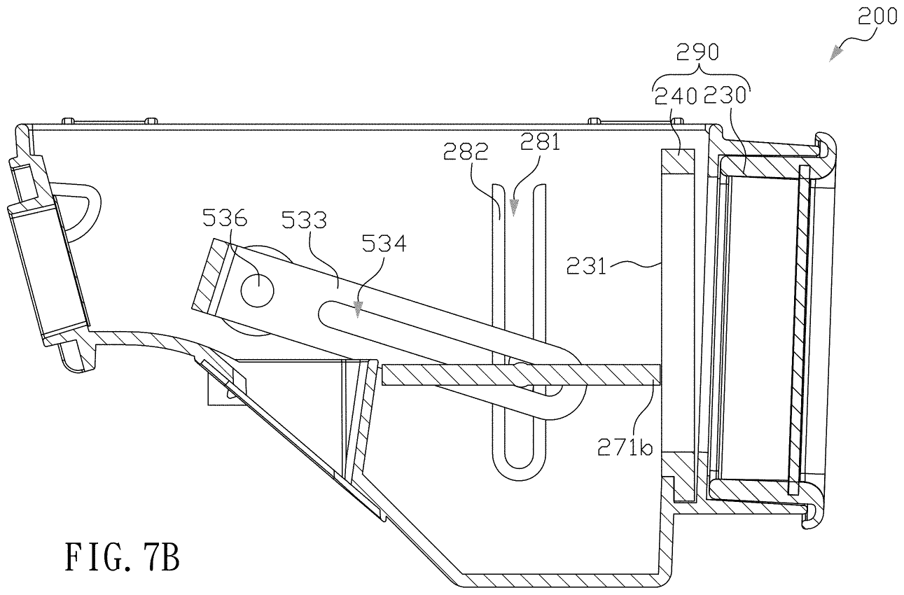

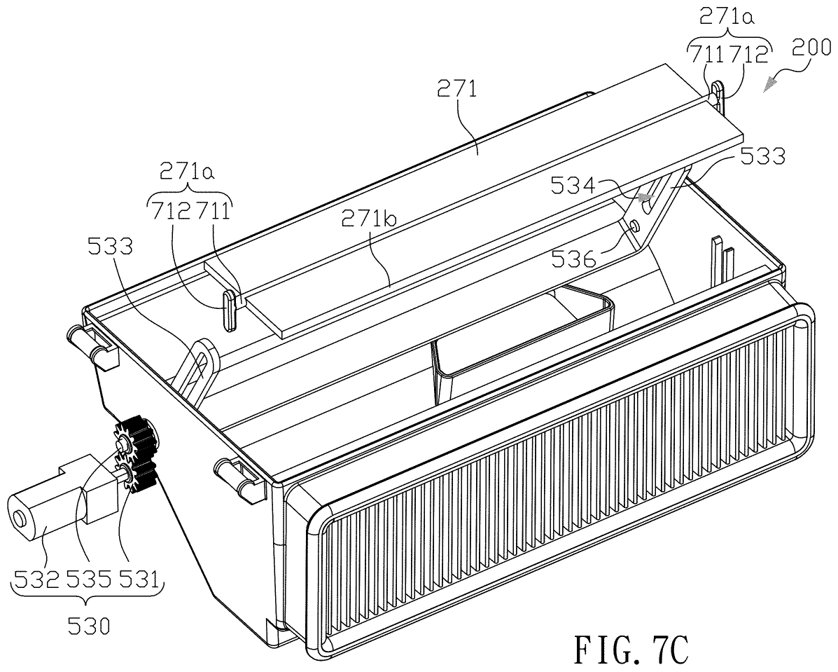

FIG. 7A shows a three-dimensional diagram of a state of a dust compressing member of a dust box according to an embodiment of the present invention. FIG. 7B shows a side view of a state of a dust compressing member of a dust box according to an embodiment of the present invention. FIG. 7C shows an exploded view of a dust box according to an embodiment of the present invention. As shown in FIG. 7A, FIG. 7B and FIG. 7C, in one embodiment, the plate of the dust compressing member 271 is a flat board, and the driving device 530 is configured such that the dust compressing member 271 moves from the upper side of the dust box 200 to the lower side of the dust box 200. A guide groove 281 is formed on at least one inner side surface 210A of the dust box 200, and the guide groove 281 extends from the upper side to the lower side of the dust box 200. In this embodiment, the guide groove 281 is formed on each of the inner side surface 210A and another inner side surface that is opposite. Preferably, the guide groove 281 is formed by a space defined by two long pins 282 projecting from the inner side surface 210A to the interior of the dust box 200.

Also referring to FIG. 7C, the driving device 530 includes a link rod 533, a gear set 531 and the motor 532. The link rod 533 has a track groove 534 formed thereon. A pivotal end 535 of the link rod 533 is connected to the gear set 531, and the other pivotal end 536 of the link rod 533 is pivotally connected to a sidewall of the dust box 200. The motor 532 drives the link rod 533 via the gear set 531, such that the link rod 533 rotates or sways about the pivotal end 535 as an axis. The connecting portion 271a of the plate-shaped dust compressing member 271 is simultaneously located in the guide groove 281 and the track groove 534, and is movable in the guide groove 281 and the track groove 534, such that the dust compressing member 271 moves from the upper side of the dust box 200 to the lower side of the dust box 200. An extension direction of the guide groove 534 is not parallel to an extension direction of the guide groove 281.

More specifically, the connecting portion 271a further includes a connecting shaft 711, and a limiting portion 712 connected to the connecting shaft 711. The connecting shaft 711 is located in the track groove 534. The limiting portion 712 is in a long strip shape and is limited in the guide groove 281, and a shape of the limiting portion 712 matches a shape of the guide groove 281 such that the dust compressing member 271 does not rotate around the connecting shaft 711. In this embodiment, the inner surface (the surface 231) of the filter net 240 is a flat surface, so as to coordinate with a path of the movement of the cleaning portion 271b.

Also referring to FIG. 6G, in a normal condition, a gear 531b is incapable of rotating as being locked by connecting to a speed reducer or a motor. Thus, a user is faced with an issue of failure of secure engagement between two gears in the gear set 531 when the dust box 200 is installed. Compared to the embodiment in FIG. 6A, the embodiment in FIG. 7A provides a benefit that, in case of failure of secure engagement between two gears in the gear set 531, such secure engagement can be achieved by pressing the dust compressing member 271 downward. Moreover, since the dust box 200 has the fifth sidewall 210S that is curved, if it is desired to compress trash in the space 261, the embodiment in FIG. 6A provides the dust compressing member 271 with a larger area compared to the embodiment in FIG. 7A, so that more trash can be compressed.

FIG. 6G shows a side view of a dust box with a dust compressing member respectively in a compressing state and in a non-compressing state according to an embodiment of the present invention. As shown in FIG. 6F and FIG. 6G, the dust box 200 further includes an elastic element 271d. The elastic element 271d is provided on a top portion of at least one side of the dust compressing member 271, extends form the top portion to the connecting portion 271a, and thus extends to and protrudes from two side surfaces of the dust compressing member 271. As a result, when the dust compressing member 271 is in a compressing state or a non-compressing state, the elastic element 271d can be respectively located at the bottom surface 210B of the dust box 200 or within the curved fifth sidewall 210S. According to the foregoing design, when the dust compressing member 271 is in a compressing state or a non-compressing state, and in case of failure of secure engagement between a gear 531a and a gear 531b in the gear set 531, the gear 531a is allowed to rotate minutely (at a maximum of the width of one tooth) clockwise or counterclockwise, so that the dust compressing member 271 then minutely rotate clockwise or counterclockwise toward the curved fifth sidewall 210S or the bottom surface 210B by means of compressing the elastic element 271d. Thus, the failure of secure engagement between two gears in the gear set 531 can be overcome.

In one embodiment of the present invention, the dust compressing member 271 can switch from a non-compressing position to a compressing position at a predetermined time interval, so as to compress trash inside the dust box 200 and keep the trash compressed within the space on the lower side of the dust box 200; for example, trash is compressed within the space 261 between the top surface of the sidewall 280 and the bottom surface 210B of the dust box 200. Thus, the effect of reducing the number of times that a user has to clear the dust box 200 can be achieved.

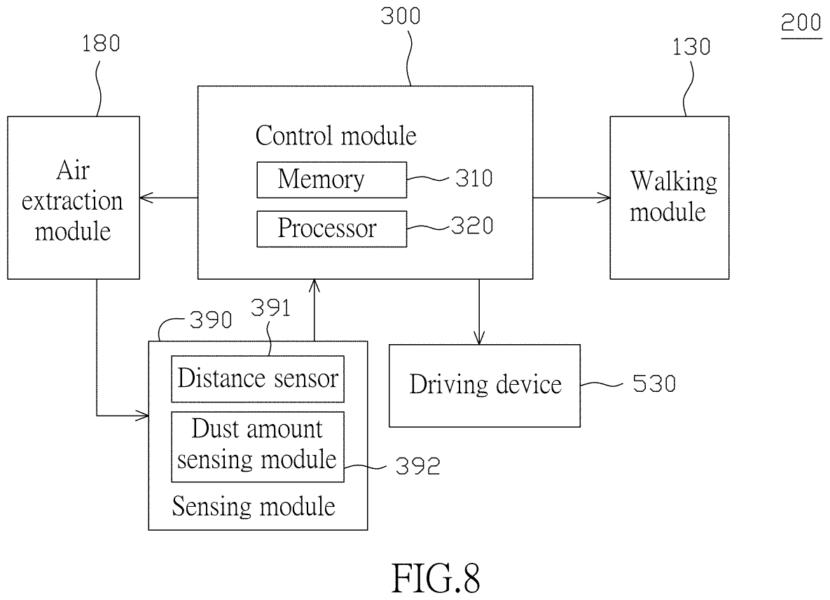

FIG. 8 shows a function block diagram of a self-propelled cleaning machine according to an embodiment of the present invention. As shown in FIG. 8, the self-propelled cleaning machine 100 further includes a control module 300 and a sensing module 390. The control module 300 is electrically connected to the walking module 130, the air extraction module 180 and the driving device 530. The control module 300 is configured to control the driving device 530 to prompt the dust compressing member 271 to be located at a non-compressing position or a compressing position. The sensing module 390 senses information of the self-propelled cleaning machine 100 walking on the floor. More specifically, the sensing module 390 includes a distance sensor 391, and obtains map information by the distance sensor 391.

The control module 300 includes a processor 310 and a memory 320. The memory 320 is coupled to the processor 310, and the memory 320 includes a non-transitory computer-readable storage medium having a computer-readable program code stored therein, wherein the computer-readable program code is executable by the processor 310 so as to perform a cleaning operation. In one embodiment, the cleaning operation includes obtaining map information by the sensing module 390, receiving a cleaning command from a remote device, and prompting the self-propelled cleaning machine 100 to perform cleaning according to the map information in response to the cleaning command. The remote device is, for example, a smart phone or a tablet computer.

In one embodiment, the control module 300 is configured to control the driving device 530 to prompt the dust compressing member 271 to switch from a non-compressing position to a compressing position at a predetermined time interval. In one embodiment, the control module 300 is configured to control the driving device 530 when the self-propelled cleaning machine 100 enters a charging station for charging, departs from the charging station, or has departed from the charging station for a predetermined period of time, such that the dust compressing member 271 switches from the non-compressing position to the compressing position.

In one embodiment, the sensing module 390 further includes a dust amount sensing module 392 for sensing an amount of dust, and the control module 300 is configured such that the dust compressing member 271 moves from the non-compressing position to the compressing position when it is determined that the amount of dust has reached a predetermined value. In one embodiment, the dust amount sensing module 392 includes an electrical sensor for sensing whether a voltage or a current of a pump or a motor of the air extraction module 180 falls within an electrical threshold range. In one embodiment, the dust amount sensing module includes an optical sensor. The optical sensor is for emitting light into the dust box 200 and then receiving the light entering the dust box 200, so as to determine whether an intensity of the light falls within an optical threshold range. In one embodiment, the dust amount sensing module includes an air pressure sensor. The air pressure sensor is for sensing whether an intensity of the air pressure in the dust box 200 falls within an air pressure threshold range. In one embodiment, when the sensing module 390 senses that the current or pressure of the air extraction module 180 has reached a threshold, the dust compressing member 271 is prompted to switch from the non-compressing position to the compressing position. At this point in time, the space within the dust box 200 is distributed with scattered trash, or the filter net 240 is fully distributed with trash, and the air pressure in the dust box 200 is then changed, or the current of the motor of the air extraction module 180 is then changed.

In conclusion of the above, in one embodiment of the present invention, the dust compressing member 271 is provided. When needed, the dust compressing member 271 can switch from a non-compressing position to a compressing position, so as to compress trash inside the dust box 200 and keep the trash compressed within the space on the lower side of the dust box 200; for example, trash is compressed within the space 261 between the top surface of the sidewall 280 and the bottom surface 210B of the dust box 200. Thus, the effect of reducing the number of times that a user has to clear the dust box 200 can be achieved.

1. A self-propelled cleaning machine, comprising:
a base;
a walking module, neighboring with the base, configured to contact a floor when the self-propelled cleaning machine moves on the floor;
a cleaning device, provided at the base, for cleaning the floor;
an air extraction module, arranged at the base, for generating an air flow between the cleaning device and the air extraction module;
a dust box, arranged at the base, being in communication with the cleaning device and the air extraction module;
a dust compressing member, mounted in the dust box, being selectively movable between a non-compressing position and a compressing position;
a driving device, connected to the dust compressing member; and
a control module, electrically connected to the walking module, the air extraction module and the driving device, wherein the control module is configured to control the driving device to move the dust compressing member to the non-compressing position or the compressing position.

2. The self-propelled cleaning machine of claim 1, further comprising:
a filter module, disposed at the dust box, and located in a path of the air flow.

3. The self-propelled cleaning machine of claim 2, wherein the dust compressing member is configured such that the dust compressing member cleans a surface of the filter module when the dust compressing member switches from the non-compressing position to the compressing position.

4. The self-propelled cleaning machine of claim 1, wherein the dust compressing member comprises a plate, the plate comprises a connecting portion and a cleaning portion, the connecting portion of the dust compressing member is connected to the driving device, and the cleaning portion and the surface of the filter module are spaced by a gap when the dust compressing member cleans the surface of the filter module.

5. The self-propelled cleaning machine of claim 4, wherein the driving device is configured such that the dust compressing member rotates about the connecting portion as an axis, the cleaning portion of the dust compressing member is located at a free end of the dust compressing member, a position of the free end is opposite to a position of the connecting portion, and the cleaning portion is configured such that the cleaning portion is spaced by a gap from the surface of the filter module during the rotating of the dust compressing member.

6. The self-propelled cleaning machine of claim 5, wherein the filter module comprises:
a filter; and
a filter net, an inner surface of the filter net serving as the surface of the filter module and facing an inside of the dust box, the air flow first passing through the filter net and then passing through the filter,
wherein the inner surface of the filter net comprises an arc surface, and a shape of the arc surface matches a path of the rotating of the cleaning portion.

7. The self-propelled cleaning machine of claim 4, wherein the plate is a flat board, and the driving device is configured such that the dust compressing member moves from an upper side of the dust box to a lower side of the dust box.

8. The self-propelled cleaning machine of claim 7, wherein
a guide groove is formed on an inner surface of the dust box, the guide groove extends from the upper side of the dust box to the lower side of the dust box,
the driving device comprises a link rod, a gear set and a motor, the link rod has a track groove formed thereon, one pivotal end of the link rod is connected to the gear set, the motor is configured via the gear set such that the link rod rotates or sways about the pivotal end as an axis,
the connecting portion of the plate is located in the guide groove and the track groove and is movable in the guide groove and the track groove, such that the dust compressing member moves from the upper side of the dust box to the lower side of the dust box, and
an extension direction of the track groove is not parallel to an extension direction of the guide groove.

9. The self-propelled cleaning machine of claim 8, wherein
the connecting portion further comprises a connecting shaft and a limiting portion connected to the connecting shaft,
the connecting shaft is located in the track groove,
the limiting portion is in a long strip shape and is limited in the guide groove, and a shape of the limiting portion matches a shape of the guide groove such that the dust compressing member does not rotate around the connecting shaft.

10. The self-propelled cleaning machine of claim 7, wherein the filter module comprises:
a filter; and
a filter net, an inner surface of the filter net serving as the surface of the filter module and facing an inside of the dust box, the air flow first passing through the filter net and then passing through the filter.

11. The self-propelled cleaning machine of claim 1, wherein the cleaning device comprises a suction port.

12. The self-propelled cleaning machine of claim 1, wherein the cleaning device comprises:
a suction port; and
a roller brush device, provided in the suction port.

13. The self-propelled cleaning machine of claim 1, wherein
the control module is configured to control the driving device at a predetermined time interval such that the dust compressing member switches from the non-compressing position to the compressing position; alternatively,
the control module is configured such that, when the self-propelled cleaning machine is being charged at a charging station, departs from the charging station, or has departed from the charging station for a predetermined period of time, the control module controls the driving device such that the dust compressing member switches from the non-compressing position to the compressing position; alternatively,
the self-propelled cleaning machine further comprises a sensing module comprising a dust amount sensing module for sensing an amount of dust, and the control module is configured such that the dust compressing member switches from the non-compressing position to the compressing position when it is determined that the amount of dust has reached a predetermined value.

14. The self-propelled cleaning machine of claim 1, further comprising:
a sensing module, capable of sensing information of the self-propelled cleaning machine walking on the floor;
wherein the control module comprises:
a processor; and
a memory, coupled to the processor, the memory comprising a non-transitory computer-readable storage medium having a computer-readable program code stored therein, the computer-readable program code executable by the processor so as to perform a cleaning operation, wherein the cleaning operation comprises:
obtaining map information by the sensing module;
receiving a cleaning command from a remote device; and
prompting the self-propelled cleaning machine to perform cleaning according to the map information in response to the cleaning command.
